(19) United States
(12) Patent Application Publication
(10) Pub. No.: US 2020/0190892 A1
(43) Pub. Date: Jun. 18, 2020

(54) DOOR COVER SYSTEM AND METHOD OF USE

(71) Applicant: David White, Abilene, TX (US)

(72) Inventor: David White, Abilene, TX (US)

(21) Appl. No.: 16/742,761

(22) Filed: Jan. 14, 2020

Related U.S. Application Data
(63) Continuation of application No. 15/274,686, filed on Sep. 23, 2016, now Pat. No. 10,533,368.

(51) Int. Cl. E06B 3/70; E06B 7/28

(52) U.S. Cl. CPC E06B 3/7001; E06B 3/673; E06B 7/28

(57) ABSTRACT

A door cover system includes a door to secure within a door structure of a building; a door cover being approximately similar in dimensions to the door, the door cover having a cover body extending from a top edge to a bottom edge and from a first side edge to a second side edge; a ledge extending from the top edge, the ledge to engage with a top of the door; a first cover body portion having a first thickness and extending from the first side edge and the second side edge; and a second cover body portion integral with the first cover body portion and extending toward a center of the cover body, the second cover body having a second thickness; the first thickness is less than ¼ inch and the second thickness is greater than the first thickness; the door cover is secured to the door such that the first cover body portion is positioned between the door and the door structure when the door is in a closed position.

### BACKGROUND

### 1. Field of the Invention

The present invention relates generally to doors, and more specifically, to a door system and method of use that allows for retrofitting an existing door for aesthetical purposes.

### 2. Description of Related Art

Doors are well known in the art and are effective means to allow a party to enter and exit a room. The doors also serve as a cosmetic feature of a room and are manufactured with different contoured and/or embossed surfaces. For example, FIG. 1 depicts a front view of a door 101 having aesthetically pleasing features, e.g., a plurality of decorative panels on the front surface.

In the exemplary embodiment, door 101 has a body 103 with two parallel sides 105 and 107 that extends from a top side 109 to a bottom side 111. A plurality of hinges is secured to side 107 and provide pivoting means as the door opens and closes. The front surface 113 includes one or more panels 117 that provide decorative means for aesthetic appearances. The door 101 is further provided with a handle 119 used to manipulate a latch 121.

One of the problems commonly associated with door 101 is the limited aesthetic appearance. For example, it is common to replace the door when the party dislikes the panel arrangement. There is no other easy and rapid means to change the panels in the art.

Accordingly, although great strides have been made in the area of doors, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a is a front view of a conventional door;

FIG. 2 is a front view of a system and method of use in accordance with a preferred embodiment of the present application;

FIG. 3 is cross-sectional view of the cover taken at III-III of FIG. 2;

FIG. 4 is cross-sectional view of the cover taken at IV-IV of FIG. 2;

FIG. 5 is a front assembled view of the system of FIG. 2; and

FIG. 6 is a flowchart depicting the preferred process.

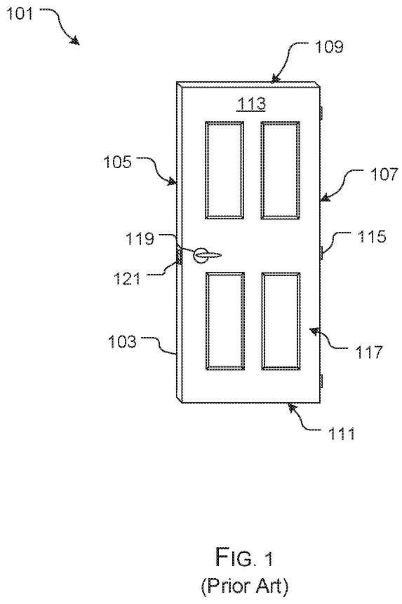

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

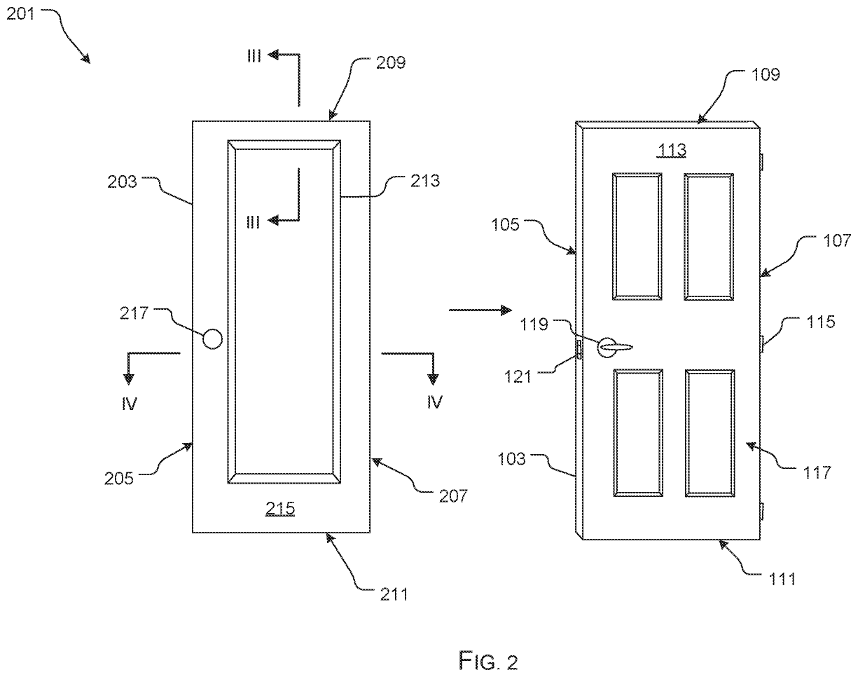

Referring now to the drawings wherein like reference characters identify corresponding or similar elements throughout the several views, FIG. 2-6 depict various views of a system 201 and method of use in accordance with a preferred embodiment of the present application. It will be appreciated that system 201 overcomes one of more of the above-listed problems commonly associated with conventional doors.

In the contemplated embodiment, system 201 is utilized with a conventional door 101 as will be discussed in depth below. Accordingly, it will be appreciated that system is configured to retrofit existing doors and to change the aesthetic appearances thereof. It should be appreciated that the conventional door 101 is any standard household door, that will be used as an entry or exit for a building, or a room within a building. It should be appreciated that although conventional household doors are approximately 36 inches wide by 80 inches tall, the system of the present invention can be adapted for variations of door size without changing the features or purpose of the present invention.

To achieve this feature, system 201 is provided with a rigid cover body 203 extending from a first side edge 205 to a second side edge 207 and extending from a top edge 209 to a bottom edge 211. The cover body 203 can include one or more aesthetical features, such as a panels 213 and/or other aesthetic features on front surface 215.

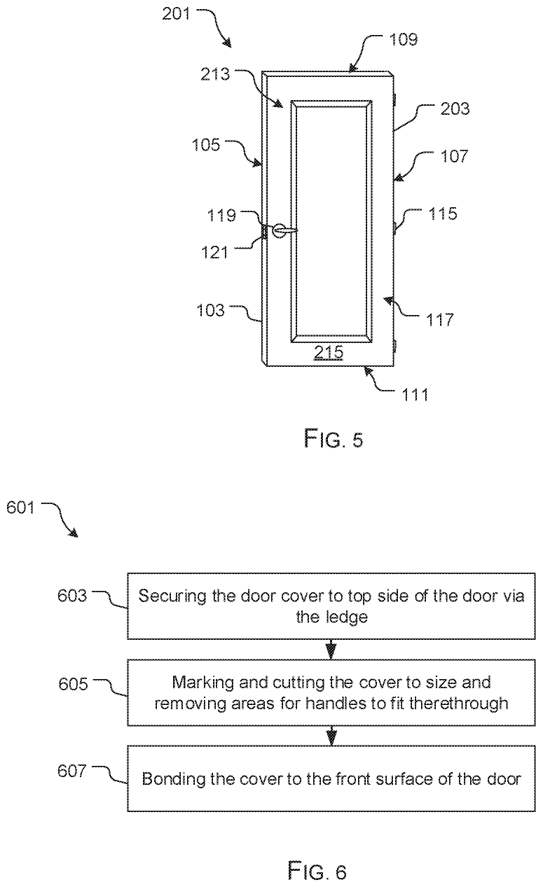

As shown in FIG. 5, the cover body 203 extends completely over front surface 113 of the conventional door and thereby changes the appearance of the door. Accordingly, it should be appreciated that the cover body 203 covers the entire front surface of the conventional door, and therefore, the size of the cover and size of the door will correlate. It is contemplated that the cover body 203 can range in size, but in one embodiment is approximately 36 inches from side to side and 80 inches from top to bottom. However, in alternative embodiments the cover body ranges in size, having a length from top to bottom of less than 12 feet and a width from right side to left side of less than 5 feet.

Accordingly, the system 201 provides effective means to change the aesthetic appearance of the door without the need for replacement. The system is easily and rapidly secured to the front surface 113 of door 101, as will be discussed more fully below.

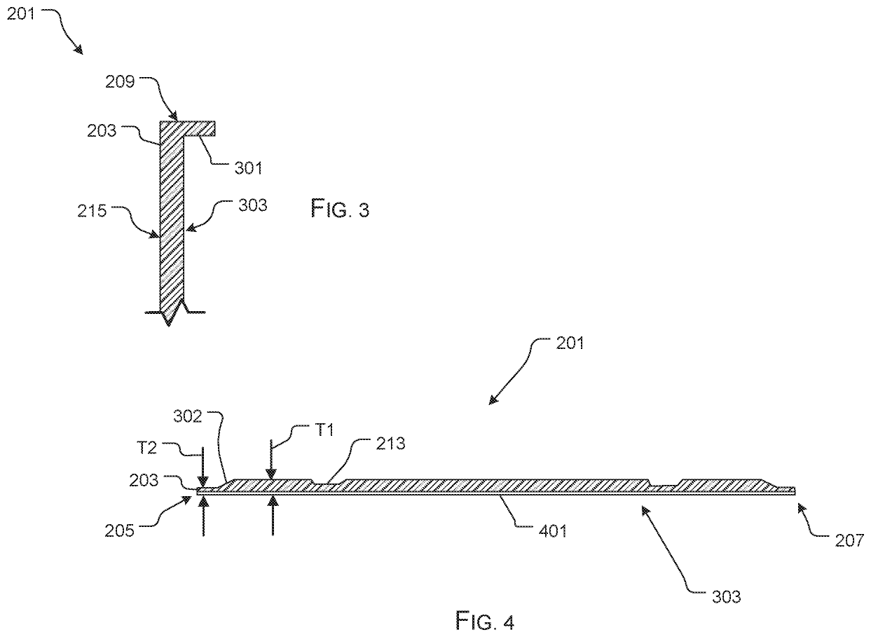

In FIG. 3, a cross-sectional view of the cover body 203 is shown. In the preferred embodiment a ledge 301 protrudes from a back surface 303 of the cover body 203 and is configured to engage with the top surface 109 of the door body 103. This feature allows the user to hang the cover body 203 to the door, which in turn enables the user to make cutting outlines for the exact width, length, and openings 217 for later cutting. After the cuts are made, the cover body is adhered to the front surface of 113 via an adhesive 401 secured to back surface 303, as depicted in FIG. 4.

In FIG. 4, a cross sectional view is taken from IV-IV to depict the varying thicknesses of cover body 203. As shown, body 203 has a first portion with a first thickness T2 that extends from edges 205, 207, wherein the first thickness T2 is thin, and therefore able to secure between the door and the door frame. This feature allows the edges to fit snugly within the points of contact between the door structure (not shown) and the edges of the door. Without this feature, the cover body would prevent the door from closing.

In the preferred embodiment, the first thickness T2 is less than ⅛ of an inch. As shown, the first thickness T2 tapers 302 toward a second body portion of the cover body 203 and up to a second thickness T1, wherein the second thickness T1 is greater than T2. The second thickness extends toward a center of the cover body. In the preferred embodiment, the second thickness T1 is less than ¾ of an inch. As shown, any embossing 213 can protrude further. It should be appreciated that the varying thicknesses are integral with one another, thereby creating a seamless cover body.

However, it should be appreciated that the embossing can vary. It should further be appreciated that the cover body 203 can vary in materials, however, in one embodiment, the cover body is composed of ABS plastic.

FIG. 5 is a front view of the system being secured to the door, while FIG. 6 is a flowchart 601 of the preferred method of assembly. The assembly steps include securing the door cover body to the door via the ledge, as depicted in box 603. Then the door cover body is marked, cut, and then bonded to the front surface of the door, as depicted with boxes 605 and 607. In the preferred embodiment, the bonding process is achieved via an adhesive with a liner used over the adhesive and removed prior to use; however, other fastening devices are also contemplated, e.g., a magnet, clip, snap, hook-loop fastener, and the like.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A door cover system, comprising:
a door configured to secure within a door structure of a building;
a door cover being approximately similar in dimensions to the door, the door cover having:
a cover body extending from a top edge to a bottom edge and from a first side edge to a second side edge;
a ledge extending from the top edge, the ledge to engage with a top of the door;
a first cover body portion having a first thickness and extending from the first side edge and the second side edge; and
a second cover body portion integral with the first cover body portion and extending toward a center of the cover body, the second cover body having a second thickness;
wherein the first thickness is less than ¼ inch and the second thickness is greater than the first thickness;
wherein the door cover is secured to the door such that the first cover body portion is positioned between the door and the door structure when the door is in a closed position.

2. The system of claim 1, wherein the door cover is approximately 36 inches wide by 80 inches tall.

3. The system of claim 1, wherein the door cover has a length of less than 12 feet and a width of less than 5 feet.

4. The system of claim 1, wherein the cover body is composed of ABS plastic.

5. The system of claim 1, wherein the second thickness is less than ¾ inch.

6. The system of claim 1, further comprising:
an embossing integral with a top surface of the cover body.

7. The system of claim 1, further comprising:
a handle opening extending through the cover body.
